(19) United States
(12) Patent Application Publication
(10) Pub. No.: US 2012/0294518 A1
(43) Pub. Date: Nov. 22, 2012

(54) CONTRAST IMPROVEMENT METHOD AND SYSTEM FOR PHOTOACOUSTIC IMAGING

(75) Inventors: Pai-Chi Li, Taipei City (TW); Chen-Wei Wei, Taipei City (TW)

(73) Assignee: NATIONAL TAIWAN UNIVERSITY, Taipei City (TW)

(21) Appl. No.: 13/557,202

(22) Filed: Jul. 24, 2012

Related U.S. Application Data
(63) Continuation-in-part of application No. 12/545,085, filed on Aug. 21, 2009.

(51) Int. Cl. G06K 9/40; G06K 9/00; G06K 9/36

(52) U.S. Cl. 382/162; 382/260; 382/264

(57) ABSTRACT

A contrast improvement method and system for photoacoustic imaging decomposes a photoacoustic image into a plurality of subband images using a set of filters, and integrates the subband images to form an integrated image. The subband images may be pseudo colored and weighted to improve contrast of the photoacoustic image.

### CROSS-REFERENCE TO RELATED APPLICATIONS

The present application is a continuation-in-part application of U.S. patent application Ser. No. 12/545,085, which is filed Aug. 21, 2009 and now pending, contents of which are incorporated herein by reference in its entirety and made a part of this specification.

### FIELD OF THE INVENTION

The present disclosure relates to photoacoustic spectroscopy, and particularly to a contrast improvement method and a contrast improvement system for photoacoustic imaging.

### BACKGROUND OF THE INVENTION

Photoacoustic spectroscopy (PAS) is based on absorption of electromagnetic radiation by a sample. The absorbed energy is measured by detecting pressure fluctuations in the form of sound waves or shock pulses. It is a non-destructive technique applicable to almost all types of samples. Therefore, PAS is widely used in analysis of biological media, such as blood, skin, and/or a tumor, for example.

The general biomedical use of PAS has been limited to relatively thin biological samples because of depth limitation of irradiation and attenuation of radiation signals. Photoacoustic contrast agents are used in measurement of blood flow, or detection and monitoring of cancer cells. Photoacoustic contrast agents can improve contrast between an artery or a tumor itself and its surroundings. However, because photoacoustic contrast agents have a limited concentration range, the degree of contrast improvement is also limited.

Therefore, a contrast improvement method for photoacoustic images is desirable to overcome the above-described deficiencies.

### SUMMARY OF THE INVENTION

The present invention is to provide a contrast improvement method and a computing system for improving the degree of contrast.

The present invention provides a contrast improvement method for photoacoustic imaging. First, a photoacoustic image is retrieved from a storage device. Then, a set of filters are calculated.

Each filter is defined as H, and H=R⁻¹Z(Z^{H}R⁻¹R)⁻¹. Wherein, R is an expected value of x(n)x^{H}(n), when a detected signal of the retrieved photoacoustic image being defined as x(n)=[x(n)x(n−1) . . . x(n−M+1)]^{T}, where n=0, . . . , N−1 and M≦N. In addition, Z=[z( ω̅₀) . . . z( ω̅₀L)], where z( ω̅)=[1e^{-j ω̅} . . . e^{- ω̅(M−1)}]^{T} and ω̅₀=arg max Tr[(Z^{H}R⁻¹R)⁻¹]. Moreover the photoacoustic image is decomposed into a plurality of subband images using the set of filters, and the subband images are integrated to form an integrated image.

From another viewpoint, the present invention also provides a computing system for improving the contrast of a photoacoustic image. The computing system has a storage device for storing a photoacoustic image, and a processor operable for executing a contrast improvement system. The processor has an image retrieving module operable to retrieve the photoacoustic image from the storage device, an image decomposing module operable to decompose the photoacoustic image into a plurality of subband images using a set of filters, and an image integrating module operable to integrate the subband images to form an integrated image. Wherein, the image decomposing module has a filter calculating unit for calculating the set of filters, where each filter is defined as H, and H=R⁻¹Z(Z^{H}R⁻¹R)⁻¹. R is an expected value of x(n)x^{H}(n), when the detected signal of the retrieved photoacoustic image being defined as x(n)=[x(n)x(n−1) . . . x(n−M+1)]^{T}, where n=0, . . . , N−1 and M≦N. In addition, Z=[z( ω̅₀) . . . z( ω̅₀L)], where z( ω̅)=[1e^{-j ω̅} . . . e^{-j ω̅(M−1)}]^{T} and ω̅₀=arg max Tr[(Z^{H}R⁻¹R)⁻¹].

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of a contrast improvement system according to a first embodiment of the present disclosure.

FIG. 2 is a flowchart of a contrast improvement method using the contrast improvement system in FIG. 1.

FIG. 3 is a block diagram of a contrast improvement system according to a second embodiment of the present disclosure.

FIG. 4 is a flowchart of a contrast improvement method using the contrast improvement system in FIG. 3.

FIG. 5 is a schematic diagram of a photoacoustic imaging setup for collecting photoacoustic signals.

FIG. 6 is a 2-D scanned image of an agar containing two objects with absorption coefficients of 41.75 cm⁻¹ (left) and 5.01 cm⁻¹ (right).

FIG. 7 illustrates spectra frequencies of each scanned line of the image in FIG. 6.

FIG. 8 illustrates peak frequencies of each scanned line of the image in FIG. 6.

FIG. 9 illustrates frequency response of three filters for subband imaging, wherein the first filter has a passband of 0-7 MHz, the second filter has a passband of 7-14 MHz, and the third filter has a passband of 14-21 MHz.

FIG. 10 is a first subband image of the image in FIG. 6 filtered by the first filter in FIG. 9.

FIG. 11 is a second subband image of the image in FIG. 6 filtered by the second filter in FIG. 9.

FIG. 12 is a third subband image of the image in FIG. 6 filtered by the third filter in FIG. 9.

FIG. 13 is a trace image of the first subband image pseudo colored in a first color.

FIG. 14 is a trace image of the second subband image pseudo colored in a second color.

FIG. 15 is a trace image of the third subband image pseudo colored in a third color.

FIG. 16 is a combination image of the trace images in FIGS. 13-15.

FIG. 17 is a lateral projection of the first subband image in FIG. 10.

FIG. 18 is a lateral projection of the second subband image in FIG. 11.

FIG. 19 is a lateral projection of the third subband image in FIG. 12.

FIG. 20 is a summed image of the first subband image in FIG. 10, the second subband image in FIG. 11, and the third subband image in FIG. 12 with equal weighting [1 1 1].

FIG. 21 is a summed image of the first subband image in FIG. 10, the second subband image in FIG. 11, and the third subband image in FIG. 12 with optimal weighting [1.06 8.53 −3.13].

FIG. 22 shows lateral projections of the image with equal weighting and the optimal weighting.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The system and the method described here below are based on medium with different absorption coefficients generating acoustic waves with different frequency contents. Generally, assuming all other conditions (e.g., sample geometry, radiation duration, or radiation area) remain the same, a high absorption medium generates acoustic waves with higher frequency components. Therefore, imaging contrast, as described below, can be improved by decomposing a photoacoustic image into a plurality of subband images using a set of filters, and appropriately selecting and combining the subband images.

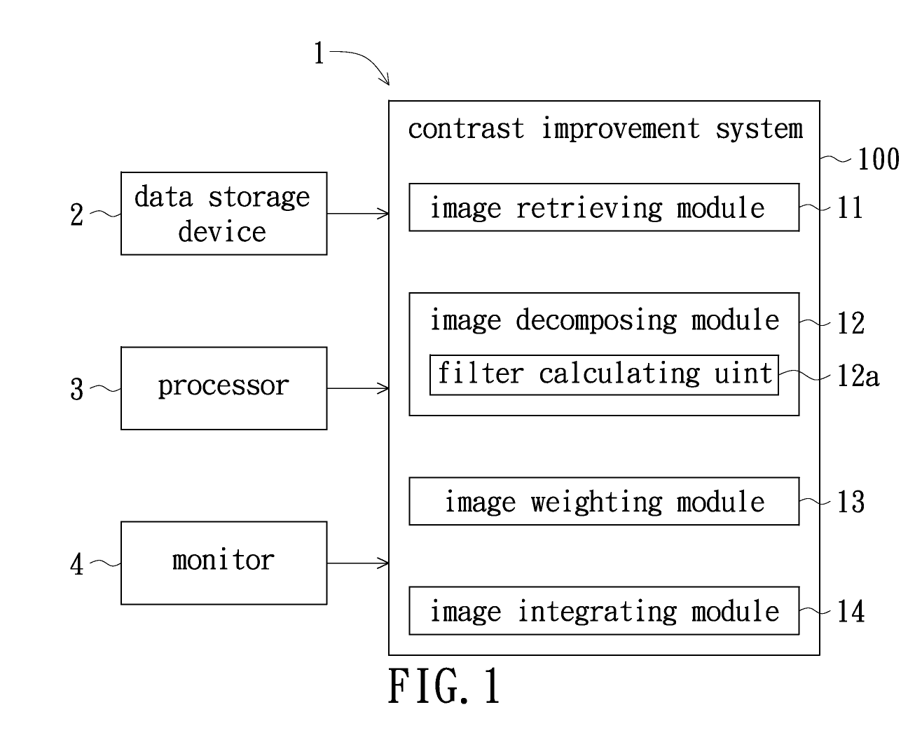

FIG. 1 is a block diagram of a first embodiment of a contrast improvement system 100 for photoacoustic imaging of the present disclosure. The contrast improvement system 100 may be used to improve contrast of a photoacoustic image. The photoacoustic image may be an image of a biological medium, such as blood, skin, and/or a tumor, for example. The contrast improvement system 100 is implemented by an electronic device 1. The electronic device 1 may be a computer, a mobile phone, a personal digital assistant (PDA) device, and any other image processing device having image processing functions.

The electronic device 1 includes a data storage device 2, a processor 3, and a monitor 4. The data storage device 2 is operable to store at least one photoacoustic image. The processor 3 executes one or more computerized operations for the contrast improvement system 100 to improve the contrast of photoacoustic images in the data storage device 2. The monitor 4 is configured for displaying the contrast improved photoacoustic images. The contrast improvement system 100 may be included in the data storage device 2 or other computer readable medium of the electronic device 1.

In the first embodiment, the contrast improvement system 100 may include an image retrieving module 11, an image decomposing module 12, an image weighting module 13, and an image integrating module 14. Each of the function modules 11-14 may comprise one or more computerized instructions that may be executed by the processor 3. The image retrieving module 11 is operable to retrieve a photoacoustic image from the data storage device 2 of the electronic device 1. The image decomposing module 12 is operable to decompose the photoacoustic image into a plurality of subband images using a set of nonoverlapping filters. The image weighting module 13 is operable to select a proper weight of each subband image. It may be understood that the weight is a coefficient assigned to the subband images in sequence in order to represent their relative importance. The image integrating module 14 is operable to integrate the subband images to form an integrated image by calculating a sum of the weighted subband images.

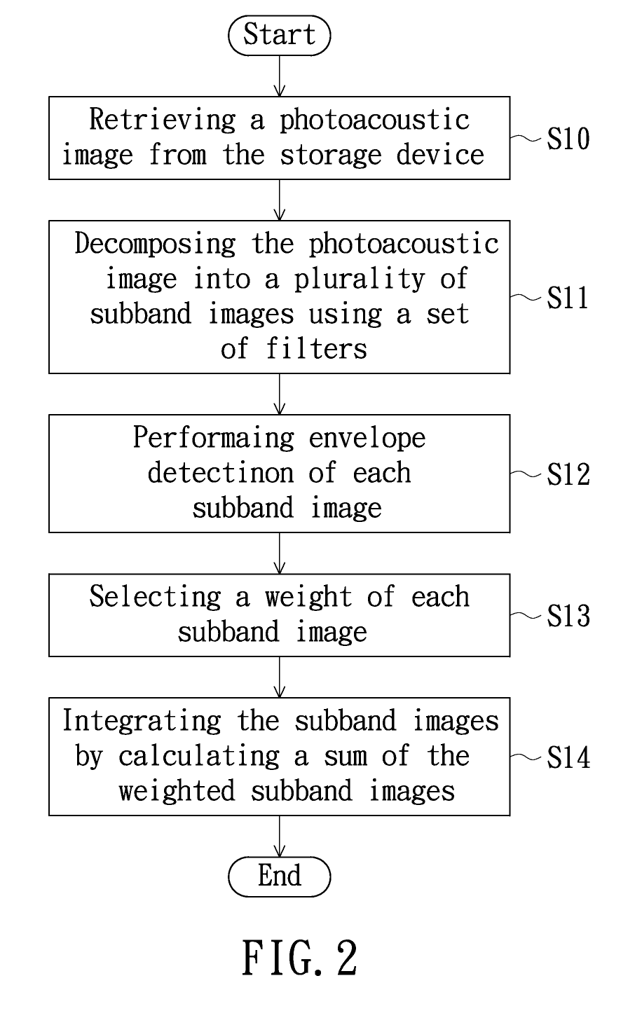

FIG. 2 is a flowchart of one embodiment of a method to improve contrast of a photoacoustic image using the contrast improvement system 100 in FIG. 1. Depending on the embodiment, additional blocks may be added, others removed, and the ordering of the blocks may be changed. In block S10, a photoacoustic image is retrieved from the data storage device 2. As mentioned above, photoacoustic image may be an image of a biological medium, such as blood, skin, and/or a tumor, for example.

If the photoacoustic image is assumed to be X(t), then in block S11, the frequency spectrum of X(t) may be divided to N subband images (X₁(t), X₂(t), . . . X_{N}(t)) with nonoverlapping frequency spectra using a set of filters. The combination of the frequency spectrum of each subband filter occupies the whole bandwidth of the frequency spectrum of the photoacoustic image. The selection of the passband and the center frequency of each of the filters can be selected according to a range of absorption coefficients of the biological medium, such as blood, skin, and/or a tumor, for example.

In block S12, envelope detection of N subband images (X₁(t), X₂(t), . . . X_{N}(t)) with nonoverlapping frequency spectra is done. The envelope detection may be performed by a squaring and low pass-filtering method or a Hilbert transform method, or other suitable kind of envelope detection method as would be known to those of ordinary skill in the art.

In one exemplary embodiment, the squaring and low pass-filtering method works by squaring an input signal, such as one of the subband images (X₁(t), X₂(t), . . . X_{N}(t)), and sending it through a low-pass filter.

In one exemplary embodiment, the Hilbert transform method creates an analytic signal of the input signal by using a Hilbert transform. It may be understood that an analytic signal is a complex signal, where the real part is the original signal and the imaginary part is the Hilbert transform of the original signal. The envelope of the signal can be found by taking the absolute value of the analytic signal.

In block S13, the subband images can be equally weighted or optimally weighted. The optimal weight of each subband image corresponds to a maximal contrast-to-noise (CNR) of two regions to be distinguished in the corresponding subband image.

In one embodiment, the CNR of the two regions to be distinguished in one subband image is defined as:

$$\begin{matrix}C N R = \frac{mean 1 - mean 2}{{[ variance 1 + variance 2 ]}^{1 / 2}} \\ = \frac{{\sum }_{k = 1}^{N} {w}_{k} {\overline{a}}_{k} - {\sum }_{k = 1}^{N} {w}_{k} {\overline{b}}_{k}}{{[ {\sum }_{j = 1}^{N} {\sum }_{k = 1}^{N} {w}_{j} {w}_{k} cov ( {a}_{j} , {a}_{k} ) + {\sum }_{j = 1}^{N} {\sum }_{k = 1}^{N} {w}_{j} {w}_{k} cov ( {b}_{j} , {b}_{k} ) ]}^{1 / 2}} ,\end{matrix}$$

where wₖ is the weighting of the k-th subband image, aₖ and bₖ are the first and second regions in the k-th subband image, ā is the mean of a, b̅ is the mean of b, cov(aⱼ,aₖ) is the covariance between aⱼ and aₖ, and cov(bⱼ,bₖ) is the covariance between bⱼ and bₖ.

The CNR can be rewritten as

$$C N R = \frac{{w}^{T} c}{{( {w}^{T} Kw )}^{1 / 2}} ,$$

where w=[w₁, w₂, . . . , wₙ]^{T} is the weighting vector for the n subband images, and c=[ā₁− b̅₁, . . . , āₙ− b̅ₙ]^{T} is the contrast vector. Let K be the sum of the covariance matrices of the two regions. Taking the first differential of the CNR with respect to w yields the values of w corresponding to the extreme CNR. In this regard, w can be solved as w=αK⁻¹c, where K⁻¹ is the inverse of K and α is a scaling factor.

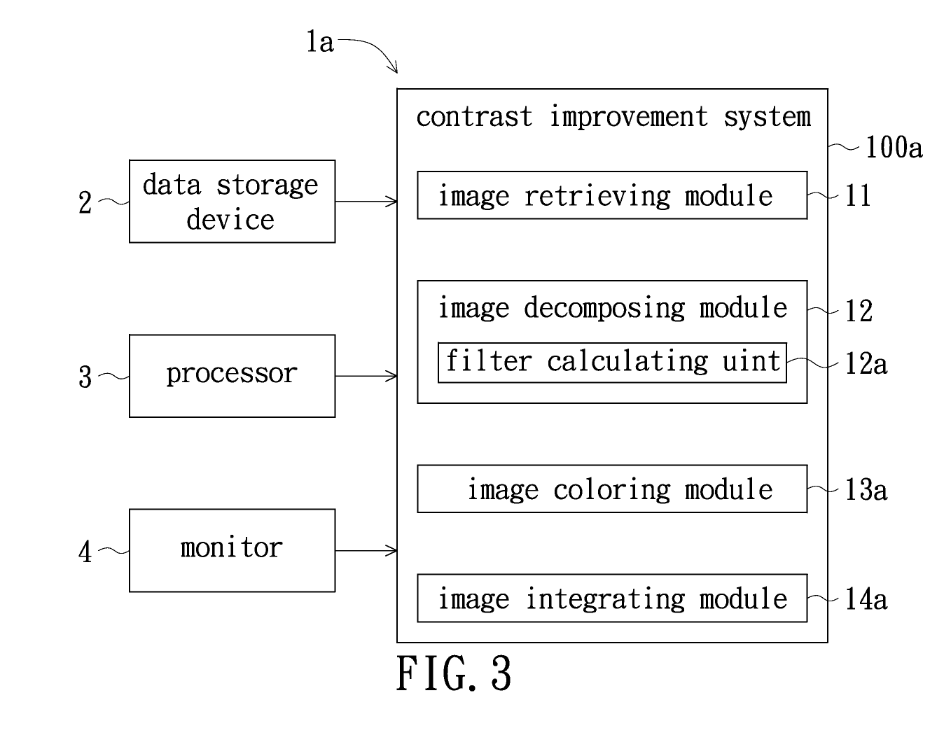

FIG. 3 is a block diagram of a contrast improvement system 100a for photoacoustic imaging according to a second embodiment of the present disclosure. The contrast improvement system 100a may be implemented by an electronic device 1a.

The electronic device 1a may be similar to the electronic device 1 in the first embodiment, and includes the data storage device 2, the processor 3, and the monitor 4.

The contrast improvement system 100a may include the image retrieving module 11, the image decomposing module 12, an image coloring module 13a, and an image integrating module 14a. Each of the function modules (11, 12, 13a, 14a) may comprise one or more computerized instructions that may be executed by the processor 3. The functions of the image retrieving module 11 and the image decomposing module 12 are similar to those in the first embodiment. The image coloring module 13a is operable to pseudo color each subband image, where the pseudo-color of each subband image is different from another subband image. The image integrating module 14a is operable to integrate the subband images to form an integrated image by combining the pseudo colored subband images.

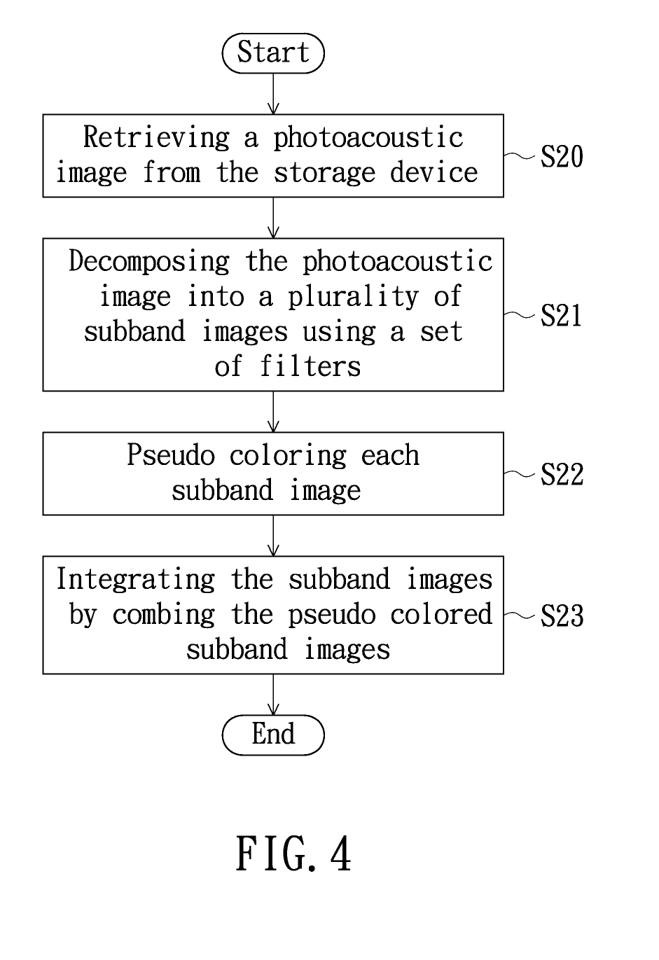

FIG. 4 is a flowchart of one embodiment of a method to improve contrast of a photoacoustic image using the contrast improvement system 100a in FIG. 3. Depending on the embodiment, additional blocks may be added, others removed, and the ordering of the blocks may be changed.

In block S20, a photoacoustic image may be retrieved from the data storage device 2, where the photoacoustic image is decomposed into a plurality of subband images using a set of filters (block S21). It may be understood that the blocks S20 and S21 are similar with the blocks S10 and S11 in the first embodiment.

In block S22, each subband image may be pseudo colored. The pseudo coloring of each subband image may be done by mapping pixel values of each subband image to a color according to a table or function. Examples of pseudo colored subband images are described below.

In block S23, the subband images are combined into a combination image. In one exemplary embodiment, the combination image may be formed by superimposing the pseudo colored subband images to form the combination image.

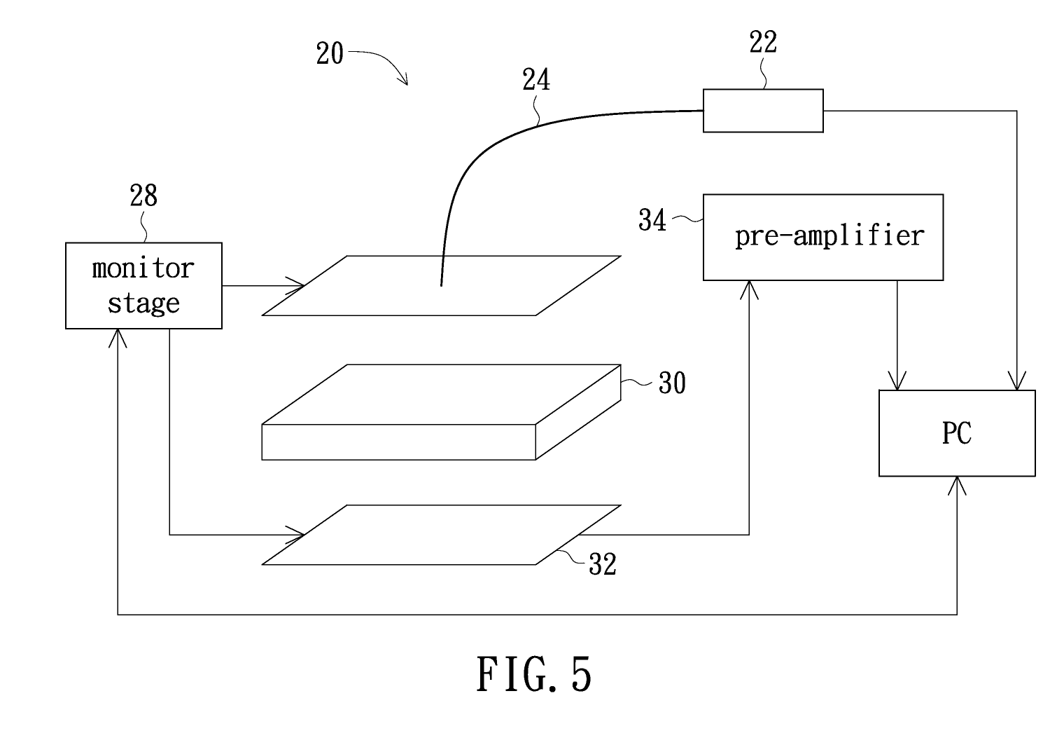

With reference to FIG. 5, the following experiment is put forth so as to provide those of ordinary skill in the art with a complete disclosure and description of how to carry out the embodiments and are not intended to limit the scope of present disclosure. It may be understood that experimental error and deviation should be accounted for numerical values of the results disclosed below.

FIG. 5 is a schematic diagram of a photoacoustic imaging setup 20 for collecting photoacoustic signals. The setup 20 includes a radiation source means 22, a projecting means 24, a scanning means 28, a sample 30 to be analyzed, an acoustical detecting means 32, and a pre-amplifier means 34. The radiation source means 20 is configured for generating radiation beams. The projecting means 24 is provided for directing the radiation beams to the sample 30. A personal computer includes the contrast improvement system (100, 100a) described above and is applied in the experiment.

In the experiment, the radiation source means 22 is a frequency-doubled Nd:YAG laser (LS-2132U, LOTIS TII, Minsk, Belarus) operating at 1064 nm with a pulse duration of 5 ns. The pulse repetition rate is 15 Hz. The projecting means 24 is a 1 mm fiber (FT-1.0-UMT, Thorlabs, Newton, N.J., USA). A laser beam emitted from the laser is coupled into the fiber to irradiate a circular area with a diameter of 3 mm, where the irradiated laser energy density is 4.72 mJ/cm². The acoustical detecting means 32 is a hydrophone (MH28, Force Technology, Brondby, Denmark) with a flat frequency spectrum from 0 to 20 MHz was used for photoacoustic signal detection. The scanning means 28 is a precision ultrasonic motor (NR-8, Nanomotion, Yokneam, Israel) controlled by the personal computer. The precision ultrasonic motor is used for scanning with a step size of 0.1 mm.

The sample 30 is made of agar with acoustic characteristics similar to those of biological tissue with a sound velocity at 1500 m/s. The sample 30 is made by first preparing Pure 2% agar (0710, AMRESCO Inc. Solon, Ohio USA), which has an absorption coefficient close to 0 cm⁻¹ at 1064 nm and is used as the background media. Subsequently, two objects whose absorption coefficients are 41.75 and 5.01 cm⁻¹ are embedded in the background media. The sample 30 is immersed in a tank (not shown) filled with deionized water for photoacoustic measurements. The acoustic waveforms are amplified by the preamplifer 34 (5073PR, Panametrics, Waltham, Mass., USA) and then sampled by a data acquisition card (CompuScope 14200, Gage, Lachine, QC, Canada) at 200 MHz. The acquired data are stored in the personal computer for subsequent data processing, and the personal computer includes the contrast improvement system 100 and 100a.

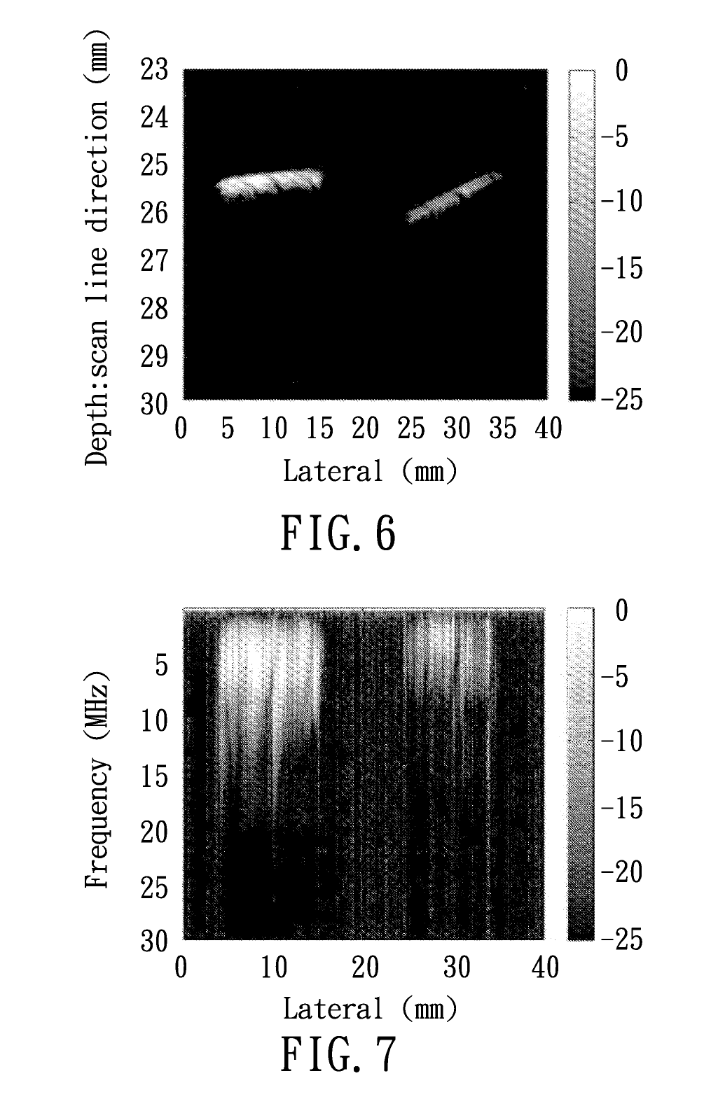

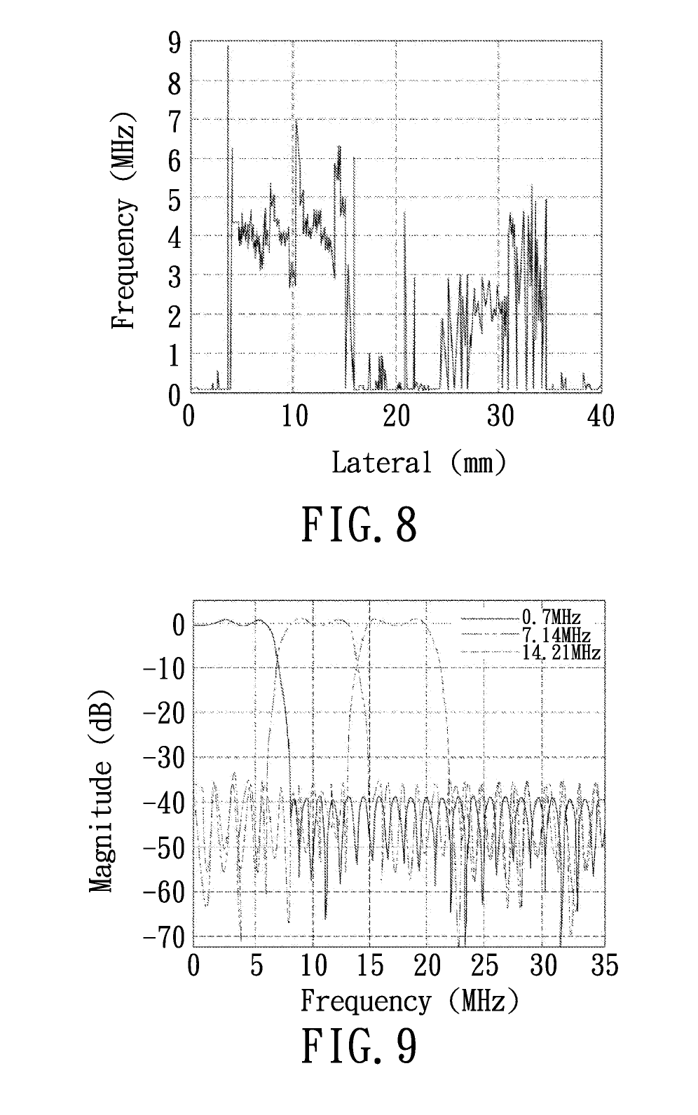

FIG. 6 shows a 2-D scanned image of the agar containing the two objects with absorption coefficients of 41.75 cm⁻¹ (left) and 5.01 cm⁻¹ (right). FIG. 7 and FIG. 8 respectively illustrate the spectra and the peak frequencies of each scanned line of the image in FIG. 6. Referring to FIG. 7, the frequency spectrum of the object with a higher absorption extends to about 14 MHz within 10 dB, whereas that of the object with the lower absorption coefficient decreases to below 20 dB at 7 MHz. FIG. 8 shows that the peak frequency is higher for the object with higher absorption coefficient than for the object with the lower absorption coefficient. The peak frequencies of the object with absorption coefficient of 41.75 cm⁻¹ are generally larger than 3 MHz, but those of the object with absorption coefficient of 5.01 cm⁻¹ are generally lower than 3 MHz.

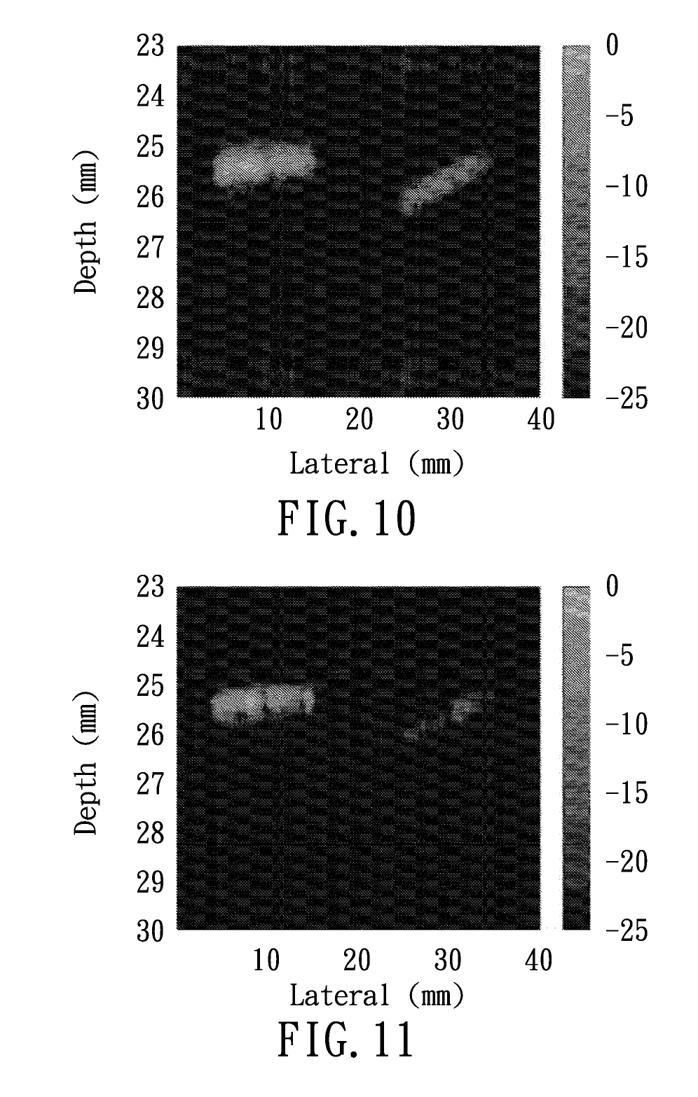

The subband images are obtained using three nonoverlapping filters whose magnitude spectra shown in FIG. 9, wherein the first filter has a passband of 0-7 MHz, the second filter has a passband of 7-14 MHz, and the third filter has a passband of 14-21 MHz. The combination of the first filter, the second filter, and the third filter occupies the whole bandwidth of the receiving hydrophone (i.e., 0-21 MHz). FIGS. 10-12 show the subband images, wherein a first subband image of the image in FIG. 6 is obtained by convolution of the first filter (0-7 MHz) and the original image data (FIG. 6), a second subband image of the image in FIG. 6 is obtained by convolution of the second filter (7-14 MHz) and the original image data (FIG. 6), and a third subband image of the image in FIG. 6 is obtained by convolution of the third filter (14-21 MHz) and the original image data.

Therefore, in some embodiments, the image decomposing module 12 (see FIG. 1) has a filter calculating unit 12a. In these embodiments, the filter selector unit 12a is configured for calculating an optimal filter design being the set of filters that pass power undistorted at specific frequencies, here the peak frequencies, while minimizing the power at all other frequencies.

Assuming the detected signal of the retrieved photoacoustic image from the image retrieving module 11 is a consecutive samples, i.e.,

x(n)=[x(n)x(n−1) . . . x(n−M+1)]^{T},

with M≦N, with ()^{T} denoting the transpose, and n=0, . . . , N−1. Next, let the output signal yₗ(n) of the lth filter having coefficients hₗ(n) as

yₗ(n)=Σₘ₌₀^{M-1}hₗ(m)x(n−m)=hₗ^{H}x(n),

with ()^{H} denoting the Hermitian transpose and hₗ=[hₗ(0) . . . hₗ(M−1)]^{H}. The output power of the lth filter can be expressed as

E{|yₗ(n)|²}=E{hₗ^{H}x(n)x^{H}(n)hₗ}=hₗ^{H}Rhₗ,

where E{} denotes the expected value and R=E{x(n)x^{H}(n)} is the covariance matrix. The total output power of all the filters is

Σₗ₌₁^{L}E{|yₗ(n)|²}=Σₗ₌₁^{L}hₗ^{H}Rhₗ.

We define a matrix H=[hₗ . . . h_{L}]. The total output power is therefore

$${\sum }_{l = 1}^{L} E \{ {\vert {y}_{l} ( n ) \vert}^{2} \} = Tr [ {H}^{H} RH ]$$

The filter bank matrix H (i.e. the optimal filter) that could minimize the total energy can be given as

H=R⁻¹Z(Z^{H}R⁻¹R)⁻¹,

where ZεC^{M×L} has a Vandermonde structure and is constructed from L complex sinusoidal vectors as

Z=[z( ω̅₀) . . . z( ω̅₀L)],

with z( ω̅)=[1e^{-j ω̅} . . . e^{-j ω̅(M−1)}]^{T}. This data and frequency dependent filter bank can then be used to estimate the fundamental frequencies by maximizing bye power of the filter's output, yielding

ω̅₀=arg max Tr[(Z^{H}R⁻¹R)⁻¹],

which depends only on the covariance matrix and the Vandermonde matrix constructed for different candidate fundamental frequencies.

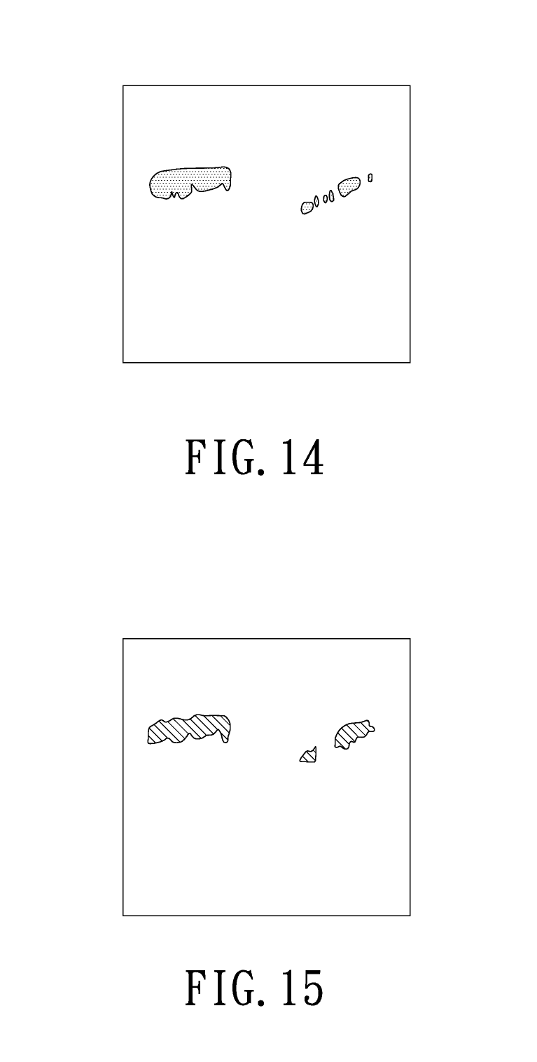

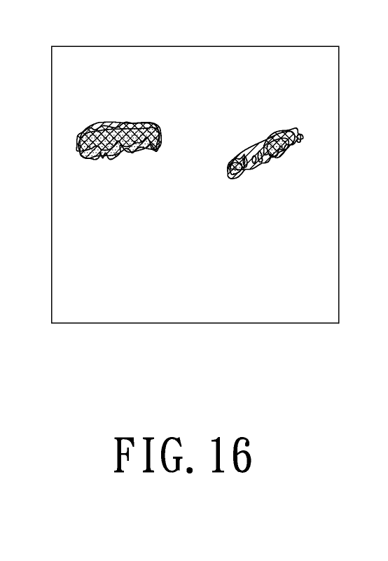

FIGS. 13-15 show trace images of the pseudo colored subband images, where FIG. 13 is a trace image of the first subband image pseudo colored in a first color (e.g., red, shown in stippling), FIG. 14 is a trace image of the second subband image pseudo colored in a second color (e.g., green, shown as triangles), and FIG. 15 is a trace image of the third subband image pseudo colored in a third color (e.g., blue, shown by hatching). FIG. 16 is the combination image obtained by superimposing the trace images in FIGS. 13-15.

In FIG. 16, the proportion of three pseudo-colors of the object whose absorption coefficients is 41.75 cm⁻¹ appears to be approximately same, which means that the photoacoustic signals contain substantial frequency components common in all three frequency spectra. In contrast, the region corresponding to the object whose absorption coefficients is 5.01 cm⁻¹ is mostly in the first color, which indicates that the frequency components are mostly within the range 0-7 MHz.

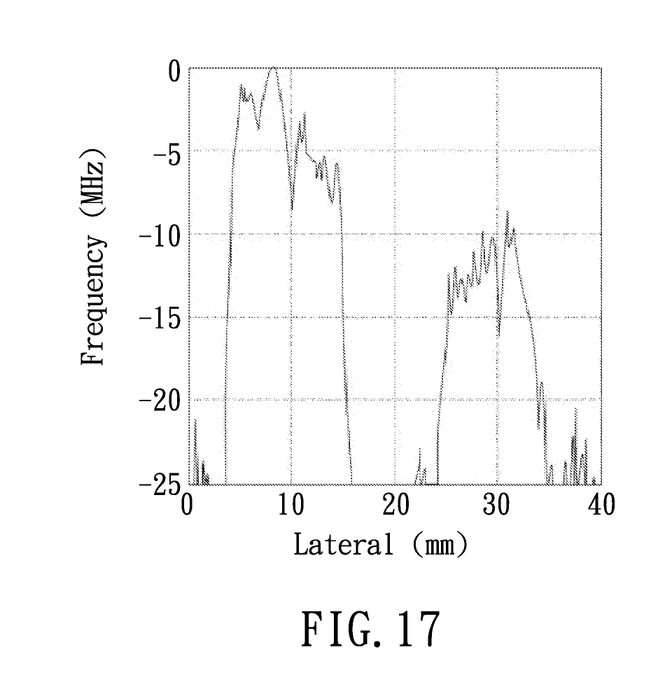

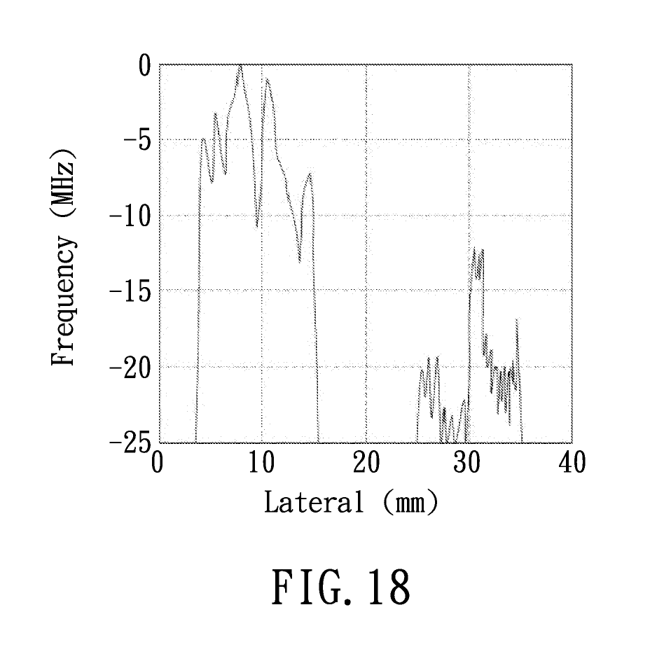

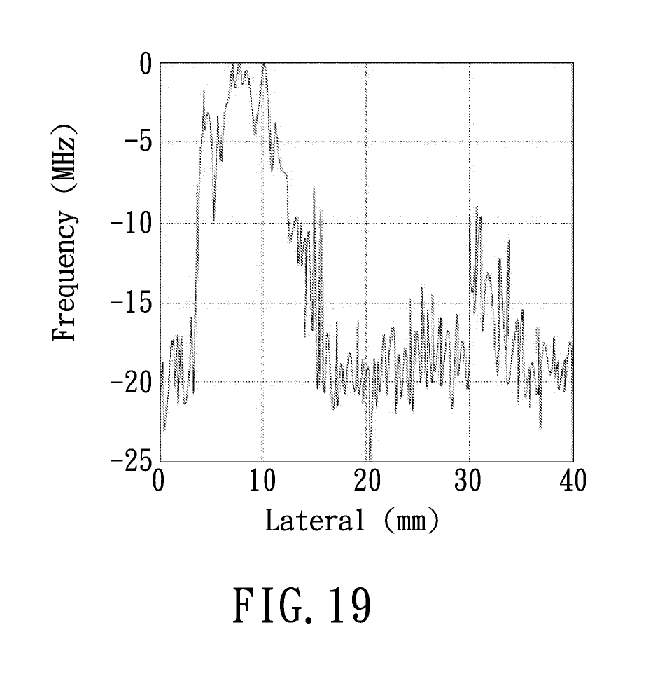

The lateral projections of the three subband images in FIGS. 10-12 are further displayed in FIGS. 17-19. The amplitude difference between the two objects, whose absorption coefficients are 41.75 and 5.01 cm⁻¹, is about 9-15 dB for 0-7 MHz frequency (FIG. 17), and increases to about 13-25 dB for 7-14 MHz frequency (FIG. 18). In other words, the contrast is increased by 4-10 dB. These results further indicate that the contrast can be effectively improved by appropriately selecting a filter.

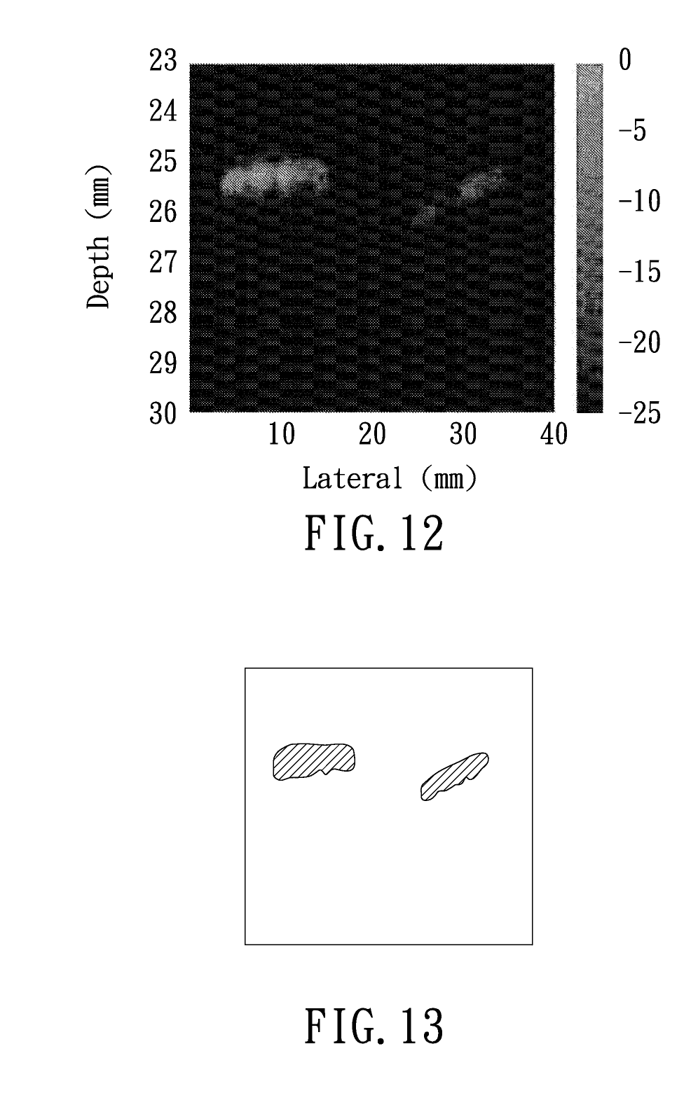

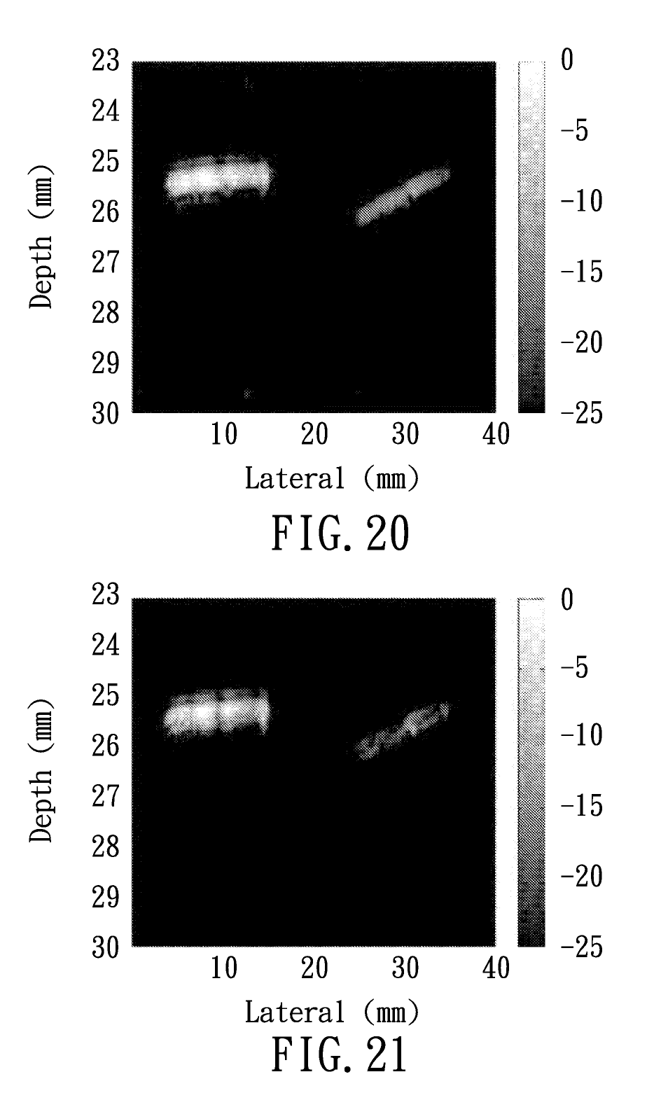

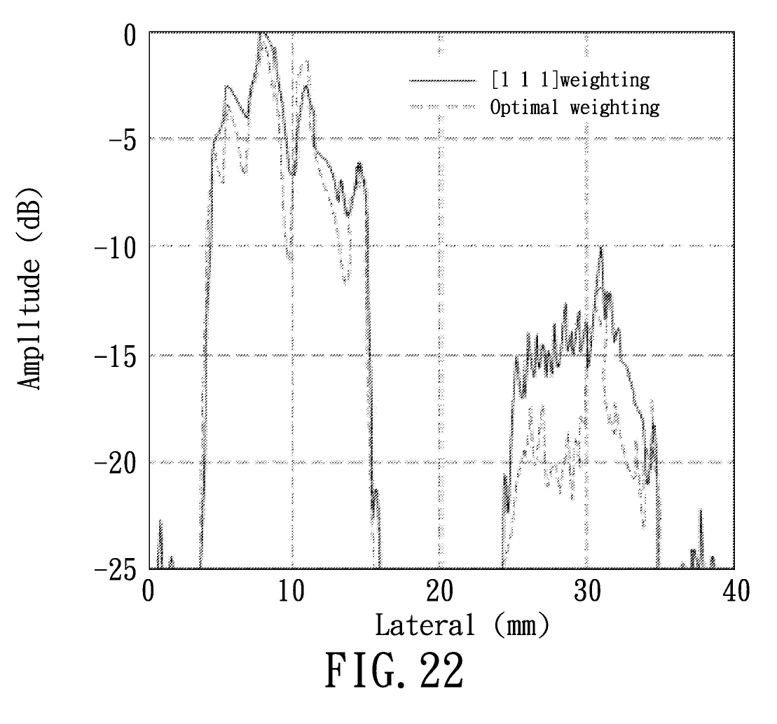

Finally, the effectiveness of optimal weighting is demonstrated in FIGS. 20-22. FIG. 20 shows the summed image of the three subband images by calculating a sum of the first subband image in FIG. 10, the second subband image in FIG. 11, and the third subband image in FIG. 12 with equal weighting [1 1 1]. On the other hand, based on equation w=αK⁻¹c, optimal weights of the first subband image, the second subband image, and the third subband image in sequence are obtained as [1.06 8.53 −3.13], and the summed image based on these weights is shown in FIG. 21. The lateral projections with the two types of weighting are shown in FIG. 22. The use of optimal weighting further enhances the contrast between images of the two objects, whose absorption coefficients are 41.75 and 5.01 cm⁻¹, by approximately 5 dB, which clearly demonstrates the effectiveness of optimal weighting.

The experiment shows that the contrast improvement methods disclosed above enhance the contrast between objects with different absorption coefficients. The contrast can be further improved by using optimal weighting or pseudo coloring.

It is understood that the results disclosed above are general. In other words, no assumptions were made regarding the nature of the images, so that the other kind of photoacoustic imaging setup can also be used to collect photoacoustic signals, and applications of photoacoustic contrast agents in the sample or the application of the arbitrary grayscale mapping or other processing can be employed to improve the contrast before processing of the photoacoustic signals using the contrast improvement system 100, 100a provided in the present disclosure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A contrast improvement method for photoacoustic imaging, the method comprising:
(a) retrieving a photoacoustic image from a storage device;
(b) calculating a set of filters, where each filter is defined as H, and H=R⁻¹Z(Z^{H}R⁻¹R)⁻¹,
wherein R is an expected value of x(n)x^{H}(n), when a detected signal of the retrieved photoacoustic image being defined as x(n)=[x(n)x(n−1) . . . x(n−M+1)]^{T}, where n=0, . . . , N−1 and M≦N; and
Z=[z( ω̅₀) . . . z( ω̅₀L)], where z( ω̅)=[1e^{-j ω̅} . . . e^{-j ω̅(M−1)}]^{T} and ω̅₀=arg max Tr[(Z^{H}R⁻¹R)⁻¹];
(c) decomposing the photoacoustic image into a plurality of subband images using the set of filters; and
(d) integrating the subband images to form an integrated image.

2. The contrast improvement method of claim 1, wherein the set of filters are nonoverlapping filters.

3. The contrast improvement method of claim 2, wherein a combination of the frequency spectrum of each filter occupies the whole bandwidth of the frequency spectrum of the photoacoustic image.

4. The contrast improvement method of claim 1, further comprising the step of selecting a weight of each subband image before block (d).

5. The contrast improvement method of claim 4, further comprising the step of performing envelope detection of each subband image before selecting the weight of each subband image, wherein the selection of the weight of each subband image is based on the envelope detected subband signals.

6. The contrast improvement method of claim 5, wherein the envelope detection is performed by a squaring and low pass-filtering method or a Hilbert transform method.

7. The contrast improvement method of claim 4, wherein the weight of each subband signal are equal.

8. The contrast improvement method of claim 4, wherein the weight of each subband signal is an optimal weight, the optimal weight of each subband signal corresponds to a maximal contrast-to-noise of two regions to be distinguished in the corresponding subband signal.

9. The contrast improvement method of claim 4, wherein the subband images are integrated by calculating a sum of the weighted subband images.

10. The contrast improvement method of claim 1, further comprising the step of pseudo coloring each subband image before block (d).

11. The contrast improvement method of claim 10, wherein the subband images are integrated by combining pseudo colored images.

12. A computing system for improving a contrast of a photoacoustic image, the computing system comprising:
a storage device operable to store a photoacoustic image; and
a processor operable to execute a contrast improvement system comprising:
an image retrieving module operable to retrieve the photoacoustic image from the storage device;
an image decomposing module operable to decompose the photoacoustic image into a plurality of subband images using a set of filters, wherein the image decomposing module having a filter calculating unit for calculating the set of filters, where each filter is defined as H=R⁻¹Z(Z^{H}R⁻¹R)⁻¹,
wherein R is an expected value of x(n)x^{H}(n), when a detected signal of the retrieved photoacoustic image being defined as x(n)=[x(n)x(n−1) . . . x(n−M+1)]^{T}, where n=0, . . . , N−1 and M≦N; and
Z=[z( ω̅₀) . . . z( ω̅₀L)], where z( ω̅)=[1e^{-j ω̅} . . . e^{-j ω̅(M−1)}]^{T} and ω̅₀=arg max Tr[(Z^{H}R⁻¹R)⁻¹]; and
an image integrating module operable to integrate the subband images to form an integrated image.

13. The computing system of claim 12, wherein the set of filters are nonoverlapping filters, and a combination of the frequency spectrum of each filter occupies the whole bandwidth of the frequency spectrum of the photoacoustic image.

14. The computing system of claim 12, wherein the contrast improvement system further comprises an image weighting module operable to select a weight of each subband image.

15. The computing system of claim 14, wherein the weight of each subband image are equal.

16. The computing system of claim 15, wherein the weight of each subband image is an optimal weight, the optimal weight of each subband image corresponds to a maximal contrast-to-noise of two regions to be distinguished in the corresponding subband image.

17. The computing system of claim 14, wherein the contrast improvement system further comprises an envelope detection module operable to envelope detect each subband image.

18. The computing system of claim 14, wherein the image integrating module operable to calculate a sum of the weighted subband images.

19. The computing system of claim 12, wherein the contrast improvement system further comprises an image pseudo coloring module is operable to pseudo color each subband image.

20. The computing system of claim 19, wherein the image integrating module is operable to combine the pseudo colored subband images.
